(19) United States
(12) Patent Application Publication
(10) Pub. No.: US 2018/0240129 A1
(43) Pub. Date: Aug. 23, 2018

(54) METHOD AND A SYSTEM OF ELECTRONIC VERIFICATION OF RELIABILITY OF GOODS INTRODUCED TO THE TRADE TURNOVER AND OF TRANSMISSION OF DATA CONCERNING THE ORIGIN OF GOODS

(71) Applicant: SUNDAY LLC, Cheyenne, WY (US)

(72) Inventor: Piotr CHUPTYS, Debica (PL)

(21) Appl. No.: 15/903,554

(22) Filed: Feb. 23, 2018

Related U.S. Application Data
(60) Provisional application No. 62/462,439, filed on Feb. 23, 2017.

(51) Int. Cl. G06Q 30/00; G06K 19/06; G06K 7/14; H04L 9/32

(52) U.S. Cl. CPC G06Q 30/018; G06K 19/06028; G06K 19/06037; H04L 9/3263; G06K 7/1417; H04L 9/3247; G06K 7/1413

(57) ABSTRACT

A method of electronic verification of reliability of goods introduced to the trade turnover and of transmission of data about the origin of the goods according to the invention is characterised in that owner of the brand (1) enters into a database (4) installed on his desktop computer (2) and with the use of said computer, generates an appropriate number of unique and unrepeatable sets of codes corresponding to the quantity of goods introduced to the trade turnover, and then the sets of codes in the computer are encrypted with the use of an encrypting algorithm (3) and transmitted, in the binary form, with the use of the database management system (5) managing said database and a data carrier (6), to the database (4) installed on the computer from where the database encrypted with the use of said database management system is transmitted to a database (8) installed on a desktop computer (9) operated by manufacturer (7) of the goods.

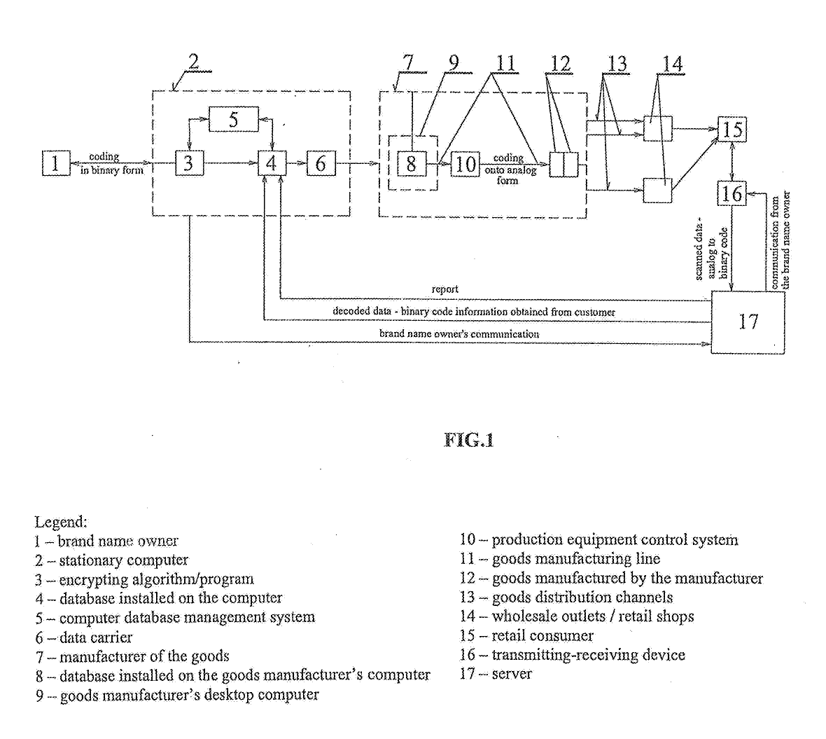

The subject of the invention is a method and system of electronic verification of reliability of goods introduced to the trade turnover and of transmission of data concerning the origin of the goods.

From patent application No. PCT/EP2003/002780 known is a method and device for identification and authentication of an object with the use of coded information placed on the object to be red out by a laser scanner equipped with at least two photoelectric detectors and decoding systems connected to them. In the first measuring channel, with the use of any known method, an open code placed on the object in the form of barcode is red out based on diversified reflection/absorption occurring in bright/dark places, whereas in the second measuring channel, a coded protective information is decrypted which is placed there in the form of protective pigments (luminescent dyes). The pigments are activated by means of barcode scanner laser light source operating, at a predefined light wavelength and show a specific luminescence in at least one different wavelength range. Further, the detector of the second measuring channel is equipped with an element selecting the wavelength.

From Polish patent application No. P-362170 known is a method and system of authentication of goods to protect against counterfeiting consisting in that the data describing goods which describe characteristic features of the goods manufactured by the manufacturer, data concerning distribution of the goods, and data describing the retail status of the goods, is stored in a database. A counterfeit-preventing serial code corresponding to the goods described by the data is then generated and transmitted to the manufacturer so that he is able to provide the goods with a label containing this counterfeit-preventing serial code. On the other hand, in reply to a customer's enquiry concerning the goods, relevant authenticating information is transmitted to such consumer, whereas the goods-related query contains the counterfeit-preventing serial code corresponding to the goods which is to be identified, and the information authenticating the goods contains at least the data concerning distribution of the identified goods

Further, from patent description No. EP 1333383 A3 known is an information providing method, a server, a program, and a memory carrier, where the method determines the way in which information is provided based on the server program and the memory carrier. Thanks to fact that the web page data is stored on different servers, of which one transmits data concerning the web page, operation is subject to a distribution, and server load is reduced. One of the servers conveys web page data to the mobile phone, said data being oriented at receiving data of an advertising banner from web pages of a second advertising server. On the other hand, the mobile phone which receives the web page data reads out the data of an advertising banner from the second advertising server. To access the web page linked with the advertising banner, the mobile telephone receives a HRL for the linked web page from the second advertising server and receives obtains web page data connected with the link.

The objective of the invention is to provide a IT-based method and a system of wireless transmission of data between a brand name (trade mark) owner, manufacturer of the goods, and consumer of the goods, allowing to maintain communication between these market participants and offering:
the customer, possibility to verify the origin of the purchased goods and acquire information whether the purchased goods comes from legal source, i.e. from the declared manufacturer, or is it an imitation of the original goods;
the manufacturer of goods marked with an original brand name, possibility to obtain reports on sales of the goods broken by geographical-territorial structure of his business and verifying whether the goods marked with his brand name and introduced to the trade turnover come actually from him;
verification of areas of operation of individual distributors of the goods marked with the brand name in question.

On the other hand, the technical problem that needed to be solved consisted in developing such a method and system of verification of data concerning the goods and the process of exchanging the related information between the manufacturer (acting as a transmitter) and the purchaser-customer (acting as a receiver) written in the form of a definite code and transmitted via a definite path, with the method and system using for the above-described purpose commonly available scanners, servers, computers, and transmitting-receiving devices, e.g. mobile phones.

The terms “code in analog form”, “code placed on goods in a secret form”, and “database management system” used in the following should be understood as follows:
the term “code in analog form” when placed on packaging of goods, means the following versions of code marked on packaging with the use of any known method, including: stamp printing, screen printing, laser engraving, thermal milling, UV ink printing, impressing, sublimation, doming in the form of 3D stickers, etching, jet printing, eroding, labelling, or with the method or using RFID (WVC) labels;
the term “code placed on goods in a secret form” means a code marked with the use of UV paint or powders, placed under a scratch-off layer, marked with the use of nanoprinting, chemically marked, in the form of a watermark, marked with the use of cryptographic methods or invisible ink, or a code marked with the use of a stenographic technique;
the term “database management system” means a computer program for collecting and processing data about a marketed goods;
the term “metadata” means information including date, hour, and location (i.e. geographical coordinates) at which the customer performed scanning of code placed on packaging of the goods.

The essential feature of the method of electronic verification of reliability of goods introduced to the trade turnover and of transmission of data concerning the origin of the goods using a coded information placed on the goods and utilising its retail status, said information being stored in a computer database, generated and conveyed to both the manufacturer of the goods who places it on the goods packaging, and to purchase-consumer of the goods offered thus the possibility to identify and check reliability of the goods consists in that the brand name owner enters to a database installed on his desktop computer and generates with the use of said computer an appropriate number of unique and unrepeatable sets of codes corresponding to the quantity of goods introduced to the trade turnover, and then the sets of codes in the computer are encrypted with the use of an encrypting algorithm and transmitted, in the binary form, with the use of the database management system managing said database and data carrier, to the database installed on the computer. Next, the database of codes encrypted this way with the use of said database management system is transmitted to a database installed on a desktop computer operated by manufacturer of the goods who in turn transmits said database to systems controlling production equipment constituting a part of the production line, where such systems convert the data on the goods from the binary form to the analog form and place sets of codes encrypted this way on packagings of finished goods, preferably in the form of QR code or barcode, whereas the goods manufactured this way with the encrypted set on codes market on it are introduced by wholesale outlets and/or retail shops to the market turnover, and after purchasing the goods, the consumer, with the use of a commonly known transmitting-receiving device equipped with the scanning function, acquires the data placed on the goods in analog form and converts it into binary data which is transmitted, together with metadata collected by the device, electronically to the data transmission server, using for this purpose a trusted encrypted data transmission system, in which the transmitted, binary data is decoded and sent to the database installed on desktop computer operated by the brand name owner where the information obtained from the consumer is red out and compared with corresponding data sent earlier to the database by said brand name owner, whereas the database management system uses a trusted data transmission system to send an appropriate communication to the server, which in turn transmits the communication to the transmitting-receiving device operated by the consumer and, in the form of a report, to the database installed on the desktop computer operated by the brand name owner as a result of which the codes are compared and the origin of goods purchased by the consumer is authenticated or not. Favourably, the database management system sends to the consumer an additional request providing for the necessity to use a next level of authentication of the goods by scanning another code from the set of codes placed on the goods. It is also favourable when the set of codes comprises at least one code, and the communication obtained from desktop computer operated by the trade mark owner is realised directly with the transmitting-receiving device operated by the consumer and when the code in the form of a QR code and/or barcode is placed by the manufacturer of goods on the goods' packaging in a place invisible the retail consumer in the course of purchasing the goods, or when the manufacturer of the goods provides the packaging with a code covered with a protective layer that can be scratched off in order to make the code visible, and transmission of data containing information concerning the origin of the goods is realised by means of an analog method and/or a digital method and/or by radio and/or via Internet-based data transmission and/or with the use of short text messages (SMSs) transmitted in digital mobile phone networks and/or in the form of text data.

On the other hand, the essential feature of the system of electronic verification of reliability of goods according to the invention consists in that it comprises a desktop computer operated by the owner of brand name under which the goods are marketed, a database installed on the computer which stores codes of the goods in the binary form, a desktop computer operated by manufacturer of the goods with database containing information transmitted to it from the brand name owner's database, and control systems of devices installed within the goods manufacturing line, where said devices convert the goods-related data from binary form to analog form, which in turn, by means of a transmitting-receiving device operated by the consumer, preferably in the form of a scanner or a mobile phone, converts a given code of the goods from analog form into binary form and, conveys it to a server coupled electrically both with the desktop computer operated by the brand name owner and with transmitting-receiving devices operated by retail consumers.

The method and the system according to the invention allow to provide the packaging of goods with a code in such form or in such place which can be scanned but cannot be red out before purchasing and thus enhances the reliability of the goods. At the same time, the method and the system allow to generate periodical reports delivered to the brand name owner. Moreover, simple acquisition and transmission of metadata in the process of scanning and conversions of the analog data placed on the goods to binary data offers the brand name owner the opportunity to trace precisely the information concerning sold quantities of goods, sale transaction frequency, and sales rates for individual lots of the goods broken by individual territories and distributors of the goods; moreover, the system is capable to warn the brand name owner in each case of sale of counterfeit of falsified goods marked with his brand name or inform him about uncontrolled multiplication of the goods. A further merit of the system according to the invention consists in its high versatility which is ensured by the use of commonly known transmitting-receiving devices available to customers and capable to be operated by them without any specialist knowledge, and moreover, the exchange of data between the brand name owner and a customer and authentication of origin of the purchased goods occurs virtually instantly thanks the use of fast data flow sources with the use of a database management system and Internet-based transmission.

Among the merits of the method and the system according to the invention one can number also the possibility offered by the system to the brand name owner who, after receiving the data, may additionally establish two-way communication with a customer's transmitting-receiving device with the use of a server or with bypassing the server which allows to exchange queries and answers containing e.g. information about the customer satisfaction level related to the actual purchase transaction or a submitted commercial offer.

The subject-matter of the invention is described in more detail in example embodiments and illustrated in a figure representing the block diagram of a wireless system for application of the method.

### EXAMPLE 1

The system of electronic verification of reliability of goods introduced to the trade turnover is realised by the owner of brand name used to mark the marketed goods, the manufacturer of the goods, and the consumer in five successive steps consisting in that:
in the first step, a brand name owner 1 who is going to introduce goods marked with his brand name to the trade turnover, generates preferably using mathematical methods, including the use of digital signature, digital certificate and “block chain”' technology, with the use of his own personal desktop computer 2, an appropriate number of codes corresponding to the quantity of goods introduced to the retail trade turnover, whereas each of these sets of codes is unique and unrepeatable, said sets of codes being then encrypted by the computer with the use of its encrypting algorithm 3 and transmitted in a binary form to database 4 and the corresponding database management system 5; next,
in the second step, the brand name owner 1, using the management system 5 managing, his database 4, transmits this database of encrypted sets of codes with the use of a known data carrier 6 to the manufacturer 7 of the goods who in turn introduces said database of codes to his own database 8 installed on his personal desktop computer 9 which, in the course of manufacturing process, introduces successively, in agreement with the brand name owner 1, an appropriate number of codes from the obtained set of codes to control systems 10 of appropriate devices installed within the goods manufacturing line 11 where said systems convert the goods-related data from binary form to analog form, place encrypted codes on sales packagings of finished goods in places invisible to the customer at the moment of purchase in the form of QR code, barcode, or in other visual form, including a graphical form, or cover the codes with a protective layer which can be scratched off to make the code visible; and then
in the third step, the goods 12 manufactured this way with encrypted codes or sets of codes in analog form placed on packagings are distributed via commonly known distribution channels 13 to appropriate wholesale outlets and/or retail shops 14 in which the goods are purchased directly by the target consumer 15; next,
in the fourth step, the consumer, with the use of commonly known transmitting-receiving devices 16, e.g. an optical device equipped with a scanning function such as a scanner or a mobile phone, acquires data placed on the goods in analog form and with the use of these devices, using known methods and algorithms, converts (transforms) the data into binary data and sends them with the use of an analog transmission method to an appropriate data transmission server 17 with the use of an encrypted data transmission system, and then the server decodes the data-information concerning the goods and transmits the data to database 4 in the desktop computer 2 in which the brand name owner 1 has stored earlier (in the first stage) the data of all codes from the set of codes before encryption; then,
in the fifth step, in the database 4 installed on computer 1, the brand name owner 1 reads out, preferably using mathematical methods, including the use of digital signature, digital certificate and “block chain” technology the information obtained from the consumer 15 and compares said information with corresponding data sent by him to the database 4 of his computer 2 (checking authenticity), whereas depending on consistency or inconsistency of the information, the database management system 5 may send to the consumer 15 an additional request to make use of the next level of authentication of the goods 12 by scanning another code from the set of codes, and after obtaining such information, transmits an appropriate communication with the use of a trusted data transmission means to server 17 which, in turn, transmits the communication to the scanning device 16 operated by the consumer 15 and, in the form of a report, to the desktop computer 2 operated by the brand name owner 1; and moreover, in additional steps the system allows for
two-way communication between the brand name owner 1 and the consumer 15, being at the same time a return reply to the report sent by server 17 by sending correspondence by means of the server in case when data placed on the goods' packaging and scanned by the consumer 15 are inconsistent with the data placed on the goods 12 by the goods manufacturer 7 in the database 8 created by the manufacturer which was transmitted to the database 3 installed on the desktop computer 2 operated by the brand name owner 1 who, as a part of the data transmission process, performed a comparison of the codes; and for
sending, by the transmitting-receiving device 16 operated by the consumer 15, the so-called metadata which, after being transmitted to the database 4, are used to compile detailed reports containing, among other things: frequency of transactions of sale of the goods in question, region-specific data concerning quantities of the goods sold, and times and locations at which the scanned codes were inconsistent with those stored in the database 4 by the brand name owner 1, whereas the reports created this way are stored in the database and then, additionally, are conveyed by the server 17 to the brand name owner in the form of a summary report.

### EXAMPLE 2

The brand name owner 1, in the course of generating codes on his PC class desktop computer 2 with the use of encrypting algorithm 3, stores in the database installed on his computer a portion of code known only to him and defining a specific manufacturer of branded goods 12, and using a known data carrier 6, conveys the sets of coded to said manufacturer, and in case of the sets of codes being conveyed to several manufacturers of the goods, their PC-class computers 2 will store sets of codes with such manufacturer-specific portion allowing the owner to verify the codes after being scanned with the use transmitting-receiving device 16 operated by consumer 15 (purchaser of the goods), whereas the data is transmitted to the owner also in a report obtained by him from server 17.

In further example embodiments of the system according to the invention, the data transmission was realised with the use of known transmission methods, including the use of digital signature, digital certificate and “block chain” technology, including analog data transmission, Internet-based data transmission, in the form of a digital transmission, and in the form of text data, whereas codes on the goods' packaging, were placed in a secret form or invisible to the recipient (consumer) of the goods at the moment of purchase whereas the packaging was also provided with an additional code possible to be red out with the use of the scanning method before purchasing the goods or the codes were placed on the finished product in a form covered with a protective layer which could be scratched off to make the code visible (known commonly from lottery scratch cards). Moreover, the communication between the computer 2 operated by the brand name owner 1 with the transmitting-receiving device 16 operated by the consumer 15 was realised also with the server 17 being bypassed or the transmission between the brand name owner 1 and the consumer was realised by means of short text messages (SMSs) transmitted via mobile phone networks.

1. A method of electronic verification of reliability of goods introduced to the trade turnover and of transmission of data concerning the origin of the goods using a coded information placed on the goods and defining retail status of the goods, said information being also stored in a computer database, generated and transmitted both to manufacturer of the goods, who places the information of packagings of the goods, and to purchaser-consumer of the goods who is offered the possibility to check identity and reliability of the goods characterised in that the brand name owner (1), using his desktop computer (2), generates an appropriate number of unique and unrepeatable sets of codes corresponding to the quantity of goods introduced to the trade turnover and introduces the codes to a database (4); next, the sets of codes are encrypted with the use of an encrypting algorithm (3) installed on said computer and with the use of the database managing system (5) managing said database and a data carrier (6), said sets of codes are transmitted in the binary form to the database (4) installed on the computer; then, said database management system is used to transmit the encrypted database of codes to a database (8) installed on a desktop computer (9) operated by manufacturer (7) of the goods who in turn transmits said encrypted database of codes to control systems (10) of appropriate devices installed within the goods manufacturing line (11) where said devices convert the goods-related data from binary form to analog form and place the encrypted codes on sales packagings of finished goods (12), preferably in the form of QR code or barcode; next, the goods manufactured this way with encrypted set of codes placed thereon are introduced by wholesale outlets and/or retail shops (14) to the trade turnover, and after purchasing the goods, the consumer (15), with the use of any known transmitting-receiving device (16) equipped with a scanning function, acquires the data placed of the goods in analog form, converts the data to the binary form, and transmits the data, together with metadata collected by said device electronically to a data transmission server (17) using for this purpose a trusted encrypted data transmission system, where the transmitted binary data is decoded and sent to a database (4) installed on the desktop computer (2) operated by the brand name owner (1), where the information obtained from the consumer is red out and compared with appropriate data sent earlier to said database by said brand name owner, whereas the database management system (5) uses a trusted data transmission system to transmit an appropriate communication to the server (17) which in turn transmits them to the transmitting-receiving device (16) operated by the consumer (15) and, in the form of a report, to the database (4) installed on the desktop computer (2) operated by the brand mark owner (1) as a result of which the data are compared and the origin of the goods (12) purchased by the consumer (15) is authenticated or not.

2. The method according to claim 1 characterised in that the data management system 5 transmits to the consumer (15) an additional request prompting him to make use of the next level of authentication of the goods (12) by scanning another code from the set of codes placed on the goods (12).

3. The method according to claim 1 characterised in that the set of codes comprises at least one code.

4. The method according to claim 1 characterised in that the communication desktop computer (2) operated by the brand name owner (1) is realised directly with the transmitting-receiving device (16) operated by the consumer (15).

5. The method according to claim 1 characterised in that the manufacturer (7) of the goods (12) provides packagings of the goods with a code in the form of QR code and/or barcode placed in a location invisible in the course of the goods being purchased by a retail consumer (15).

6. The method according to claim 1 characterised in that for creating and recovering code/codes, are used mathematical methods of checking authenticity, including digital signature digital certificate and “block chain” technology.

7. The method according to claim 1 characterised in that the manufacturer (7) of the goods (12) provides packaging of the goods with a code covered under a protective layer which can be scratched off to make the code visible.

8. The method according to claim 1 characterised in that the transmission of data concerning the origin of the goods (12) is realised with the use of an analog method.

9. The method according, to claim 1 characterised in that the transmission of data concerning the origin of the goods (12) is realised with the use of a digital method.

10. The method according to claim 1 characterised in that the transmission of data concerning the origin of the goods (12) is realised by radio.

11. The method according to claim 1 characterised in that the transmission of data concerning the origin of the goods (12) is realised via the Internet-based data transmission.

12. The method according to claim 1 characterised in that the transmission of data concerning the origin of the goods (12) is realised with the use of short text messages (SMSs) transmitted via digital mobile phone networks.

13. The method according to claim 1 characterised in that the transmission of data concerning the origin of the goods (12) is realised in the form of text data.

14. A system of electronic verification of reliability of goods introduced to the trade turnover and of transmission of data concerning the origin of goods marked with an appropriate code, said system using a scanner, a server, a program, a memory carrier, and a mobile phone characterised in that it comprises a desktop computer (2) operated by owner (1) of the brand of goods (12) introduced to the trade turnover, a database (4) installed on said computer and storing codes of the goods in the binary form, and a desktop computer (9) operated by manufacturer (7) of the goods, said computer having installed a database (8) containing information transmitted from the database (4) and control systems (10) of appropriate devices installed within the goods manufacturing line (11) where said systems convert the goods-related data from binary form to analog form, which in turn, by means of transmitting-receiving devices (16) operated by the consumer (15), preferably in the form of scanner or a mobile phone, converts a given code of the goods from analog form to binary form and transmits it to a server (17) coupled electrically both with the desktop computer (2) operated by the brand name owner (1) and with the transmitting-receiving devices (16) operated by the retail consumer (15).
